(19) United States
(12) Patent Application Publication
(10) Pub. No.: US 2026/0359614 A1
(43) Pub. Date: Nov. 12, 2026

(54) STORAGE MEDIUM STORING A PROGRAM, INFORMATION PROCESSING APPARATUS, AND METHOD OF CONTROLLING THE SAME

(71) Applicant: CANON KABUSHIKI KAISHA, Tokyo (JP)

(72) Inventor: TAMAO SATO, Kanagawa (JP)

(21) Appl. No.: 19/666,846

(22) Filed: May 4, 2026

(30) Foreign Application Priority Data
May 12, 2025 (JP) 2025-079852

(51) Int. Cl. G06N 3/0475; G06N 3/045

(52) U.S. Cl. CPC G06N 3/0475; G06N 3/045

(57) ABSTRACT

An information processing apparatus accepts input of a prompt, sets one or more usable generative AIs and usage conditions for the generative AIs. The information processing apparatus determines, based on the accepted prompt and the set usage conditions, a target generative AI to process the prompt, included in the usable generative AIs, and performs control to output the prompt to the target generative AI, so that the information processing apparatus causes the target generative AI to perform processing of the prompt and receives a result of the processing from the target generative AI.

### BACKGROUND

### Field of the Technology

The present disclosure relates to a storage medium storing a program, an information processing apparatus, and a method of controlling the same.

### Description of the Related Art

In recent years, the use of generative artificial intelligence (generative AI) technology has been increasing in fields such as academia and business. Examples of this include tasks such as having generative AI create documents or using generative AI to create source code.

When using generative AI, users use different generative AIs depending on the content of the prompt. However, if a generative AI is incorrectly selected due to human error or the like, it is possible that data may be unintentionally transmitted to the outside. To solve such issues, Japanese Patent Application Laid-Open No. 2023-27525 discloses a technology that automatically determines the transmission destination of information to be sent to a generative AI according to the content of the data and the situation.

Information input to generative AI by a user may include data that is prohibited from being disclosed to the external Internet, such as personal information or highly confidential information. Accordingly, for example, in a case where a plurality of generative AIs are available to a user, it is conventionally necessary for the user to select only a highly secure generative AI that does not leak personal information or highly confidential information onto the Internet, based on corporate rules, a confidentiality level, and the like.

### SUMMARY

Embodiments of the present disclosure eliminate the above-mentioned issues with conventional technology.

According to embodiments of the present disclosure, there is provided an information processing apparatus comprising: one or more controllers including one or more processors in communication with one or more memories, the one or more controllers configured to: accept input of a prompt; set one or more usable generative AIs and usage conditions for the generative AIs; determine, based on the accepted prompt and the set usage conditions, a target generative AI to process the prompt, included in the usable generative AIs; and perform control to output the prompt to the target generative AI, thereby causing the target generative AI to perform processing of the prompt, and to receive a result of the processing from the target generative AI.

Further features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a diagram showing an example of a configuration of a system according to each embodiment of the present disclosure.

FIG. 2A is a block diagram for describing a hardware configuration of an information processing apparatus according to a first embodiment.

FIG. 2B is a block diagram for describing a hardware configuration of a cloud according to each embodiment.

FIG. 2C is a block diagram for describing a hardware configuration of an information processing apparatus according to a second embodiment.

FIG. 3A is a functional block diagram for describing a software configuration of an information processing apparatus according to the first embodiment and a third embodiment.

FIG. 3B is a functional block diagram for describing a software configuration of a cloud according to each embodiment.

FIG. 3C is a functional block diagram for describing a software configuration of an information processing apparatus according to the second embodiment.

FIGS. 4A-4G are diagrams for describing screen transitions when generative AI to be used is set in each embodiment of the present disclosure.

FIGS. 5A-5D are diagrams for describing examples of screens when generative AI is used in each embodiment of the present disclosure.

FIGS. 6A and 6B are sequence diagrams for describing a processing flow when a generative AI that a user wishes to use and usage conditions of the generative AI are set in each embodiment of the present disclosure.

FIGS. 7A and 7B are flowcharts for describing a processing flow of the entire system when processing is executed using a generative AI based on a prompt input via the information processing apparatus according to the first embodiment.

FIGS. 8A and 8B are flowcharts for describing a processing flow when processing is executed using a generative AI based on a prompt input via the information processing apparatus according to the second embodiment.

FIGS. 9A and 9B are flowcharts for describing a processing flow when processing is executed using a generative AI based on a prompt input via the information processing apparatus according to the third embodiment.

FIG. 10 is a diagram for describing examples of items in which generative AI usage conditions according to the first embodiment hold conditions, and data.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

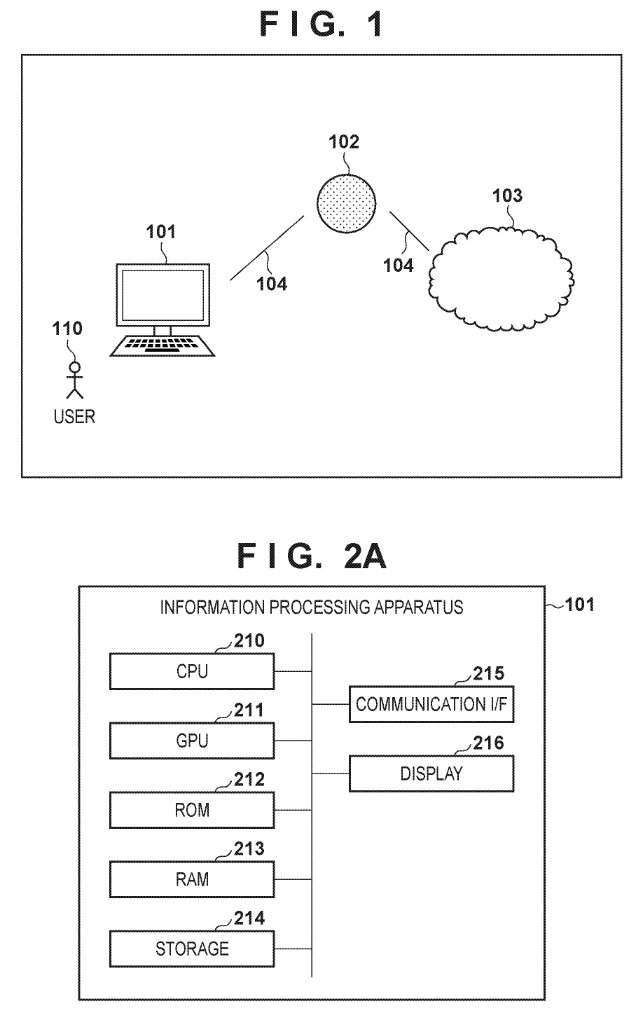

FIG. 1 is a diagram for describing an example of a configuration of a system according to embodiments of the present disclosure.

This system includes an information processing apparatus 101 and a cloud 103, and the information processing apparatus 101 and the Internet 102 are connected via a network 104. A user 110 can operate the information processing apparatus 101 to register generative AIs, usage conditions of the generative AIs, and the like, and can also use a generative AI by inputting a prompt. Further, the cloud 103 and the Internet 102 are connected via the network 104. Here, it is assumed that the configuration of a general-purpose computer that realizes the cloud 103 is implemented by utilizing hardware resources supplied on demand via virtualization technology. Note that the network 104 here may be wired or wireless.

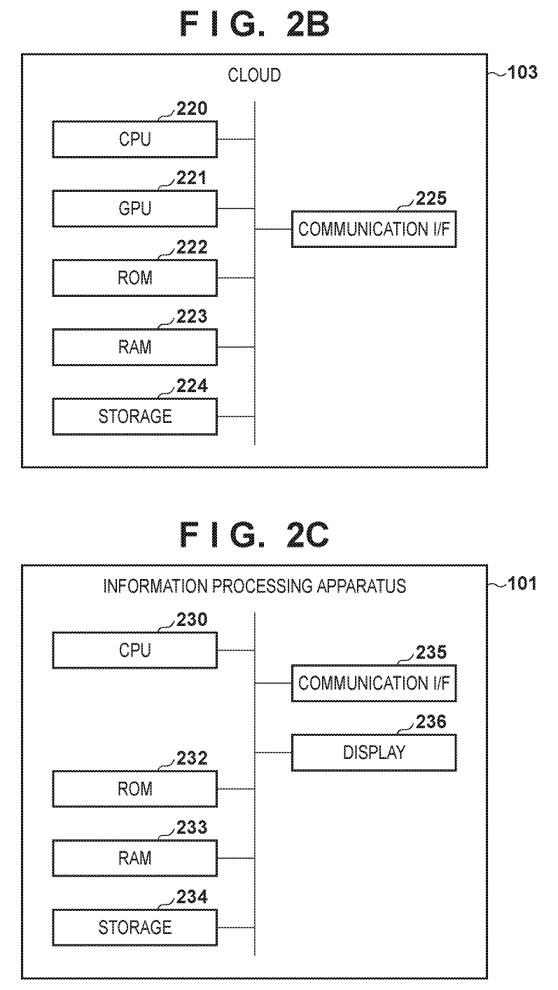

FIGS. 2A and 2B are block diagrams for describing hardware configurations of the information processing apparatus 101 according to the first embodiment and the cloud 103 according to the embodiments.

The information processing apparatus 101 in FIG. 2A includes a CPU 210, a ROM 212, a RAM 213, a storage 214, a communication I/F 215, and a display (operation unit) 216.

The CPU 210 controls the overall operation of the information processing apparatus 101. The CPU 210 performs various controls such as printing and reading, data calculations, and the like, by loading a control program stored in the ROM 212 or the storage 214 into the RAM 213 and executing the control program. When AI or generative AI is used, a graphics processing unit (GPU) 221 may be used to perform various controls, data calculations, and the like.

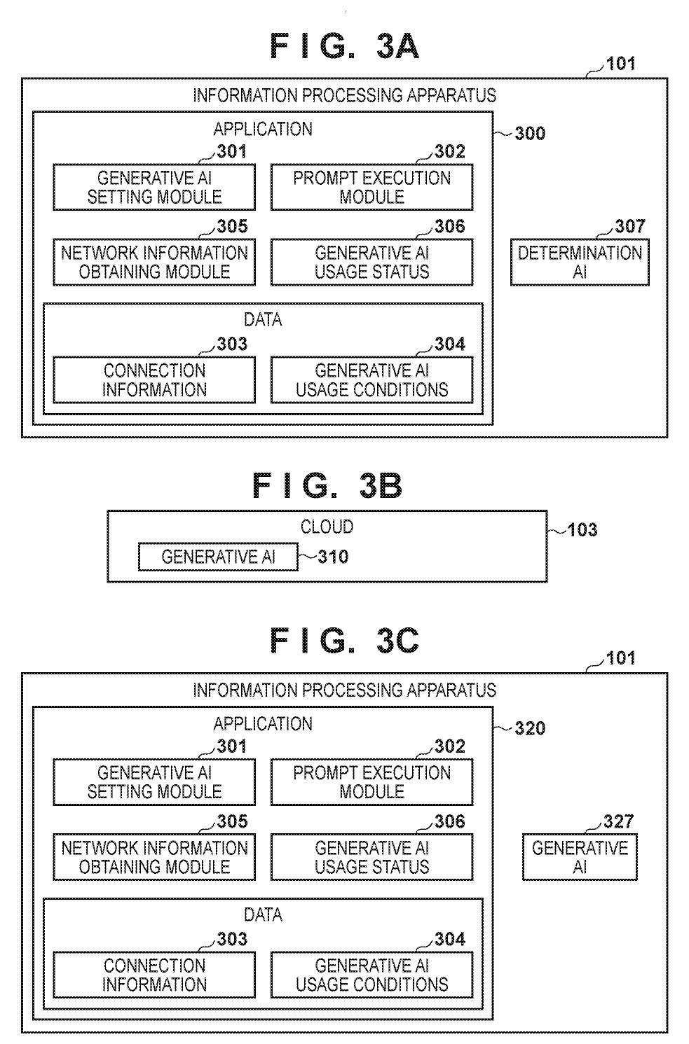

The ROM 212 stores executable control programs and the like. The CPU 210 executes various types of processing by loading a control program stored in the ROM 212 into the RAM 213 and executing the control program. The RAM 213 is a main memory for the CPU 210, and is also used as a work area for the CPU 210 and a temporary storage area for loading various control programs stored in the ROM 212 and the storage 214. The storage 214 stores print data, image data, various programs, various types of setting information, and the like, in addition to control programs executable by the CPU 210. The communication I/F 215 is an interface for communication with an external system such as the cloud 103. The display 216 has a touch panel function, and displays a generative AI setting module 301 (FIG. 3A) and accepts input from the user, and displays a prompt execution module 302 (FIG. 3A) and accepts input from the user. Further, the display 216 also functions as an operation unit capable of accepting voice input and key operations by the user. Note that a prompt refers to an instruction or a question input by the user in, for example, a natural language format, and the input of the prompt may be input via key operations by the user, reading of a code or the like, user voice input, or the like.

FIG. 2B is a block diagram for describing a hardware configuration of a general-purpose computer that realizes the cloud 103 according to the embodiments of the present disclosure.

The cloud 103 includes a CPU 220, a GPU 221, a ROM 222, a RAM 223, a storage 224, and a communication I/F 225. The CPU 220 controls the overall operation of the cloud 103. The CPU 220 performs reading of various types of data, various controls such as printing and reading, data calculations, and the like, by loading a control program stored in the ROM 222 or the storage 224 into the RAM 223 and executing the control program. In the case of a generative AI program, the GPU 221 may be used to execute various controls and perform data calculations. The ROM 222 stores control programs and the like executable by the CPU 220. The ROM 222 is controlled by the CPU 220, and the CPU 220 executes various types of processing by loading a control program stored in the ROM 222 into the RAM 223 and executing the control program. The RAM 223 is a main memory for the CPU 220, and is used as a work area and a temporary storage area for loading various control programs stored in the ROM 222 and the storage 224. The storage 224 stores print data, image data, various programs, various types of setting information, and the like, in addition to executable control programs. The communication I/F 225 is an interface for communication with an external device such as the information processing apparatus 101. Note that hardware resources such as the CPU 220, the ROM 222, and the like included in the cloud 103 are provided on demand via virtualization technology. The cloud 103 functions as a virtual server on a cloud computing environment as these hardware resources are provided on demand via virtualization technology.

FIGS. 3A-3C are functional block diagrams for describing software configurations of the information processing apparatus 101 and the cloud 103 according to the embodiments. FIG. 3A is a functional block diagram of the information processing apparatus 101 according to the first embodiment and a third embodiment.

An application 300 implemented in the information processing apparatus 101 includes the generative AI setting module 301, the prompt execution module 302, a network information obtaining module 305, and a generative AI usage status 306. Furthermore, the application 300 includes connection information 303 and generative AI usage conditions 304 as data. Further, a determination AI 307 is included as a function of the information processing apparatus 101.

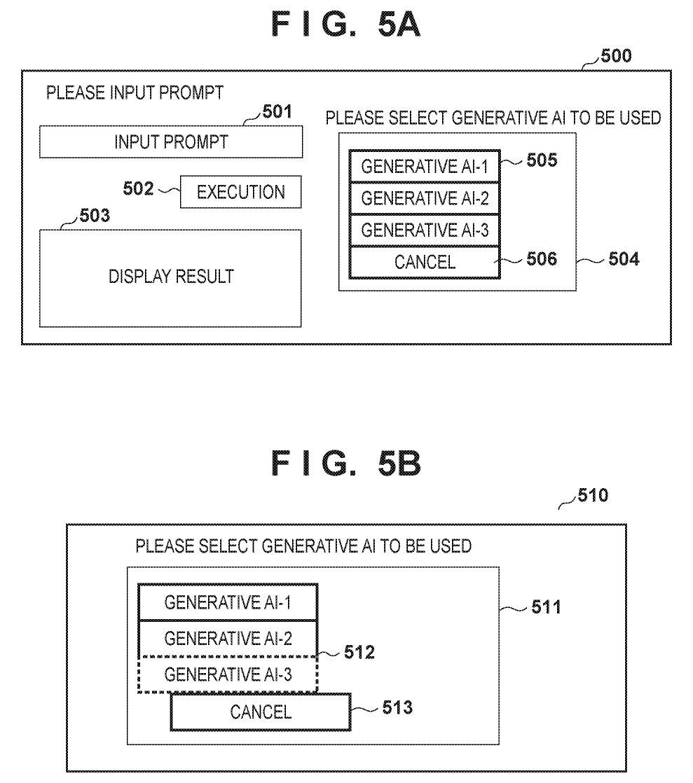

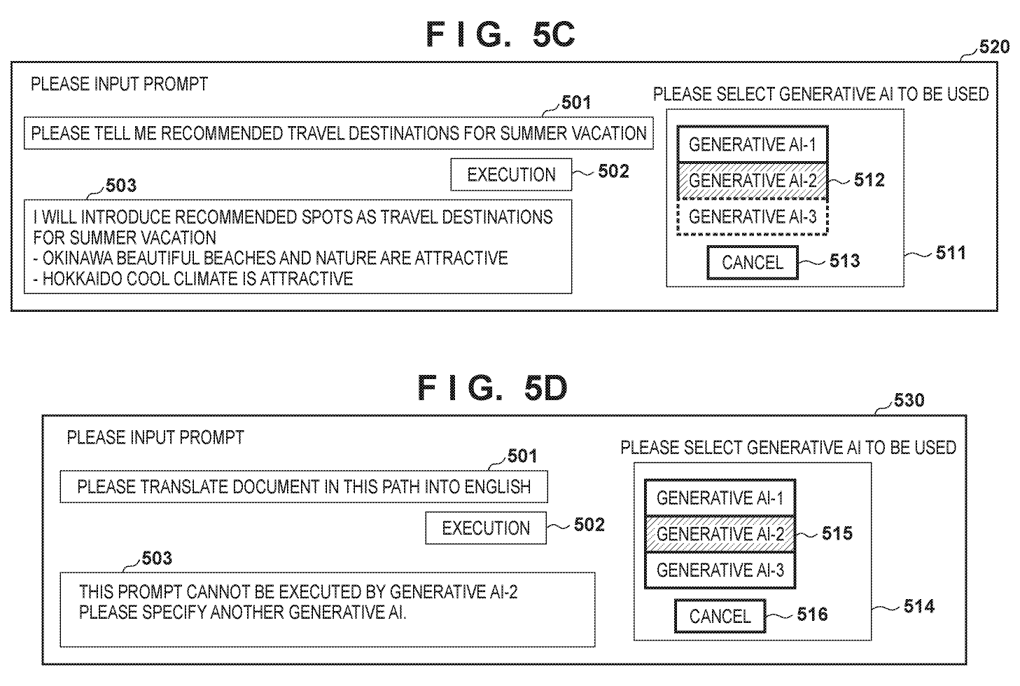

The application 300 is capable of setting generative AI and inputting and outputting a prompt. The generative AI setting module 301, which is a function of the application 300, displays a setting screen on the display 216 to set generative AI. Further, the prompt execution module 302, which is a function of the application 300, displays a prompt input and output screen 500 (FIG. 5A) on the display 216 to input and output a prompt.

The connection information 303 holds connection information set by the user via input and output through the generative AI setting module 301. In the first embodiment, the storage format of the connection information 303 is a text format, but any storage format such as a database or the like may be used. Further, the location where the connection information 303 is stored may be a location other than the information processing apparatus 101 operating the application 300. Note that this connection information 303 includes, for example, the presence or absence of a connection with a network, authentication information, and the like.

The generative AI usage conditions 304 hold generative AI usage conditions set by the user via input and output through the generative AI setting module 301. The generative AI usage conditions 304 include keywords or images serving as usage conditions, the file path of the determination AI 307, and furthermore, whether or not the target generative AI is usable when any of the keywords is included, and the like.

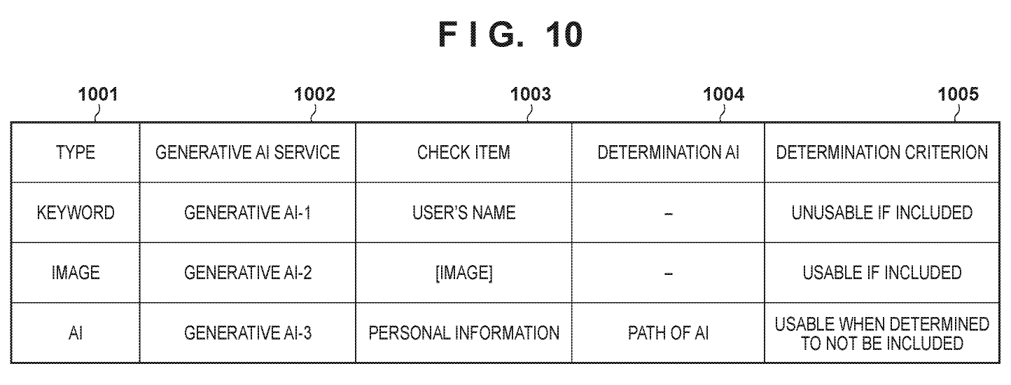

FIG. 10 is a diagram for describing examples of items in which the generative AI usage conditions 304 according to the first embodiment hold conditions, and data. In FIG. 10, the first row indicates data types, and the second to fourth rows indicate examples of data.

The generative AI usage conditions 304 hold five items for each piece of data: a type 1001, a generative AI service 1002, a check item 1003, a determination AI 1004, and a determination criterion 1005. The type 1001 indicates a type of determination condition, and three types, namely keyword, image, and AI, are assumed here. The generative AI service 1002 indicates a generative AI that is a target of restriction. The check item 1003 is an item to be checked when using a generative AI. The determination AI 1004 indicates the path of the determination AI in a case where whether or not the target generative AI is usable is determined using the determination AI registered by the user. The determination criterion 1005 indicates a determination criterion for whether or not the target generative AI is usable. For example, in a case where a generative AI-1 is to be made unusable when the user’s name is included in an input prompt, “keyword” is set in the type 1001, and the target “generative AI-1” is set in the generative AI service 1002. Further, “user’s name” is set in the check item 1003, and “unusable if included” is set in the determination criterion 1005.

In the first embodiment, the generative AI usage conditions are shown in a table format, but any data format such as a text format or a database may be used. Further, the location where the generative AI usage conditions 304 are stored may be a location other than the information processing apparatus 101 operating the application 300.

Next, the network information obtaining module 305, which is a function of the application 300, obtains network connection information. Here, usage status or the like of the Internet 102 and the network 104 is obtained. Further, the generative AI usage status 306, which is a function of the application 300, obtains the upper limit of the number of uses of the generative AI. This obtaining method may be in any form, such as obtaining from the generative AI by using an API for obtaining the number of times, or having an internal counter.

The determination AI 307 is an AI for determining the content of a prompt, and has learned information necessary for the determination in advance. For example, in a case where personal information is to be determined, information necessary for the determination of the personal information has been learned.

FIG. 3B is a functional block diagram for describing a software configuration of the cloud 103 according to the embodiments of the present disclosure.

The cloud 103 includes a generative AI 310. The generative AI 310 is a generative AI service that operates in the cloud 103.

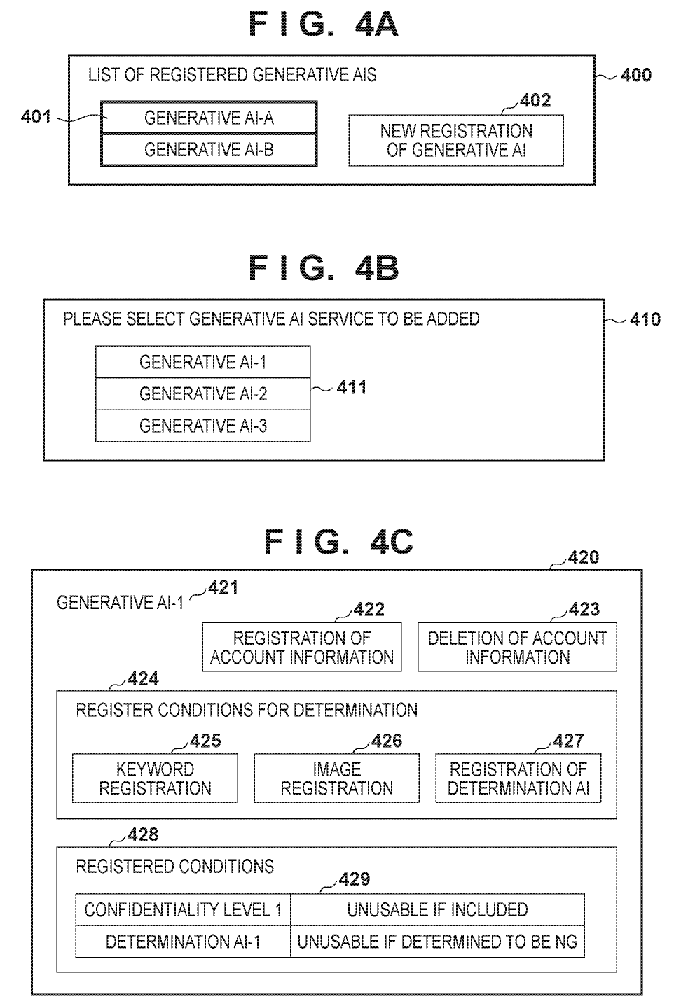

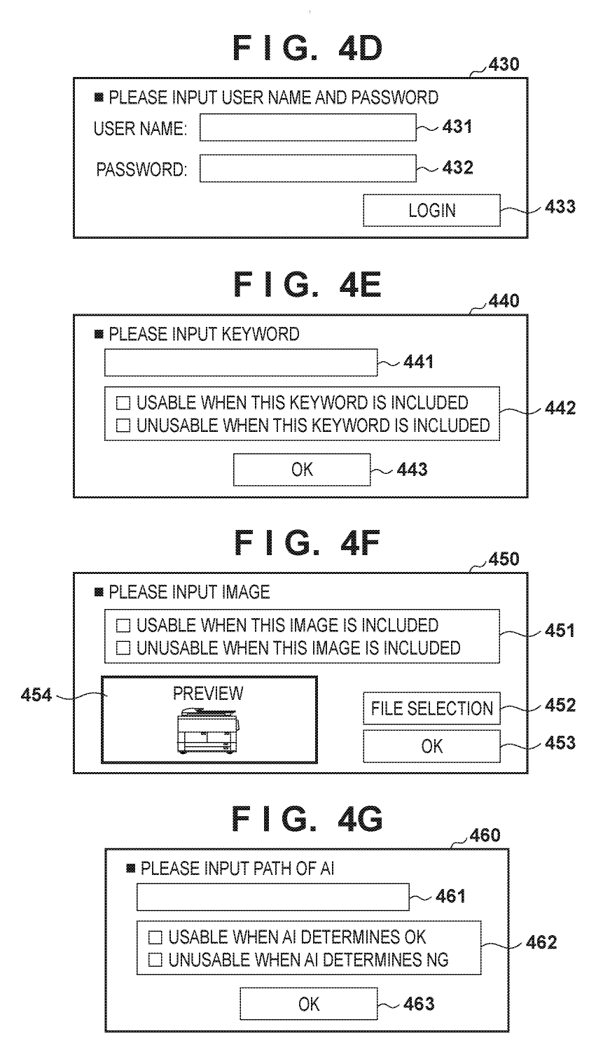

FIGS. 4A-4G are diagrams for describing screen transitions when generative AI to be used is set in the embodiments of the present disclosure. FIGS. 4A-4G depict views of examples of a user interface of the generative AI setting module 301 and are displayed on the display 216.

FIG. 4A depicts a view showing an example of a generative AI setting screen 400 displayed on the display 216 of the information processing apparatus 101 according to the embodiments.

On the setting screen 400, generative AIs that have already been registered are displayed in a generative AI list 401. When performing new registration of a generative AI, the user presses a “new registration of a generative AI” button 402. As a result, a transition is made to a selection screen 410 shown in FIG. 4B for selecting a generative AI to be added, and the user can register a new generative AI via this screen.

FIG. 4B depicts a view illustrating an example of the selection screen 410 used to select a generative AI to be added. In a generative AI list 411, buttons corresponding to generative AIs that can be added are displayed. The generative AIs displayed in this generative AI list 411 are set by the application 300. The user presses a button corresponding to a generative AI to be added from the generative AI list 411, and the screen transitions to a setting screen 420 shown in FIG. 4C.

FIG. 4C depicts a view showing an example of the setting screen 420 used to perform setting related to the generative AI to be added, namely “generative AI-1”. The setting screen 420 shown in FIG. 4C illustrates a case where “generative AI-1” in the generative AI list 411 is selected on the selection screen 410 shown in FIG. 4B. A label 421 indicates the name of the generative AI selected on the generative AI list 411 (here, “generative AI-1”). By pressing an “account information registration” button 422, the user can register and store account information corresponding to the generative AI in the information processing apparatus 101 in advance. This eliminates the need to log in each time the user uses the generative AI. Furthermore, the user can notice an omission of registration of account information for the generative AI service before using the generative AI. When this “account information registration” button 422 is pressed, the screen transitions to an authentication screen 430 shown in FIG. 4D. An “account information deletion” button 423 is a button used to instruct deletion of the account information registered for the target generative AI.

FIG. 4D depicts a view illustrating an example of the authentication screen 430 for user authentication. The user inputs a user name (an ID or the like) and a password in an ID text box 431 and a password text box 432 of the authentication screen 430, respectively, and presses a login button 433. A text box is an interface for the user to input text information. When authentication on the authentication screen 430 is successful, the registration of the user is completed, and the screen returns to the setting screen 420 shown in FIG. 4C.

A button group 424 shown in FIG. 4C includes a plurality of buttons used to register usage conditions for a generative AI to be added (here, “Generative AI-1”). When the user presses a keyword registration button 425, the screen transitions to a keyword registration screen 440 shown in FIG. 4E to allow the user to register a keyword. Further, when the user presses an image registration button 426, the screen transitions to an image registration screen 450 shown in FIG. 4F to allow the user to register an image such as an icon. Further, when the user presses a determination AI registration button 427, the screen transitions to an AI registration screen 460 shown in FIG. 4G to allow the user to register a determination AI for determining whether or not the generative AI is usable. Further, registered conditions 428 in FIG. 4C indicate examples of registered conditions in the format of a table 429. The registered conditions 428 shown in FIG. 4C include a condition that the generative AI (“Generative AI-1”) is made unusable when “Confidentiality Level 1” is included, and a condition that the generative AI (“Generative AI-1”) is made unusable when the determination result of “Determination AI-1” is NG.

FIG. 4E depicts a view showing an example of the keyword registration screen 440 displayed when the keyword registration button 425 is pressed. The user inputs a keyword to be set, into a text box 441. Via the radio button group 442, a user can set, by selecting a radio button, whether to make the generative AI usable or unusable when a keyword input into the text box 441 is included. A radio button is a selection field represented by a mark such as “○” (a circle) or “□” (a square) on a GUI. An OK button 443 is a button used to register the content set via the text box 441 and the radio button group 442. The information in the text box 441 is registered in the check item 1003 in FIG. 10, and the information set via the radio button group 442 is registered in the determination criterion 1005 in FIG. 10.

FIG. 4F depicts a view showing an example of the image registration screen 450 displayed when the image registration button 426 is pressed. Here, the user selects an image to be set via a file selection button 452. A preview 454 displays the image of the file selected by the user via the file selection button 452. Via a radio button group 451, the user can set, by selecting a radio button, whether to make the generative AI usable or unusable when the image of the file selected via the file selection button 452 is included. An OK button 453 is a button used to register the content set via the file selection button 452 and the radio button group 451. The information of the image selected via the file selection button 452 is registered in the check item 1003 in FIG. 10, and the information set via the radio button group 451 is registered in the determination criterion 1005 in FIG. 10.

FIG. 4G depicts a view showing an example of the AI registration screen 460 displayed when the “determination AI registration” button 427 is pressed. A user inputs the file path of the “determination AI” to be set, into a text box 461. Via a radio button group 462, the user can set, by selecting a radio button, whether to make the generative AI usable when a determination result of the determination AI set via the text box 461 is “OK” or to make the generative AI unusable when the determination result of the determination AI is “NG”. An OK button 463 is a button used to register the content input via the text box 461 and set via the radio button group 462. The path information of the determination AI input into the text box 461 and the information set via the radio button group 462 are registered in the determination AI 1004 in FIG. 10 and the determination criterion 1005 in FIG. 10, respectively. In the example shown in FIG. 10, for example, when the generative AI-3 is used, if the input prompt includes personal information, the determination AI is used to make a determination to prohibit the use of the generative AI-3. In this case, “AI” is set in the type 1001, and the target “generative AI-3” is set in the generative AI service 1002. Then, “personal information” is registered in the check item 1003 in FIG. 10, the path of the determination AI is registered in the “determination AI” 1004 in FIG. 10, and “usable when the determination AI determines that the prompt does not include personal information” is set in the determination criterion 1005.

FIG. 5A depicts a view showing an example of a screen when the generative AI is used in each embodiment of the present disclosure. This figure shows a user interface of the prompt execution module 302 and is rendered on the display 216. A text box 501 is a text box into which the user inputs a prompt. In the embodiments, the input is in a text format, but may be in any format such as a PDF file or an image file.

An execution button 502 is a button used to instruct execution of a prompt input into the text box 501. An area 504 is an area displaying a button for displaying a list 505 of usable generative AIs and an execution cancel button 506. The list 505 of generative AIs is displayed based on the determination of usable generative AIs by the prompt execution module 302. A text box 503 is a text box in which an output in response to the prompt is displayed. In the embodiments, the output is in a text format, but may be in any format such as audio, a PDF, or an image file.

FIG. 5B depicts a view showing an example of a screen in which usable generative AIs are displayed in each embodiment of the present disclosure. In this screen, the example of a screen displayed in the area 504 is displayed in an area 511. For example, the user has registered the generative AI-1, the generative AI-2, and the generative AI-3 in advance via the generative AI setting module 301. For example, it is assumed that the prompt execution module 302 determines that the usable generative AIs are the generative AI-1 and the generative AI-2 based on the prompt input into the text box 501 by the user. In this case, in a button group 512 indicating the list of usable generative AIs, the usable generative AI-1 and generative AI-2 are displayed as selectable buttons. On the other hand, the generative AI-3 determined to be unusable is displayed in a non-selectable text format. Note that, in the first embodiment, usable generative AIs are displayed as buttons and unusable generative AIs are displayed as text, but any display format may be used as long as the user can identify the selectable generative AIs.

FIG. 5C depicts a view showing an example of a specific screen when generative AI is used in the first and second embodiments of the present disclosure. Now, the user has registered the generative AI-1, the generative AI-2, and the generative AI-3 in advance via the generative AI setting module 301, and the user inputs a prompt “Please tell me recommended travel destinations for summer vacation” into the text box 501 and presses the execution button 502. Accordingly, the prompt execution module 302 extracts generative AI candidates that can execute the prompt based on the value input into the text box 501, and displays the candidates as in the area 511 of FIG. 5C, for example. When the user selects “generative AI-2” in the area 511, the prompt is passed to the selected “generative AI-2.” Accordingly, the generative AI-2 executes the prompt, and the prompt execution module 302 displays a message introducing “recommended travel destinations for summer vacation” in the text box 503 as a result of the execution. In the example in FIG. 5C, Okinawa and Hokkaido are displayed as recommended travel destinations. Note that when the user has registered only one generative AI (for example, the “generative AI-1”) in advance via the generative AI setting module 301, only the active “generative AI-1” may be displayed in an input and output screen 520 in FIG. 5C, and when the execution button 502 is pressed, the prompt may be output to the “generative AI-1”.

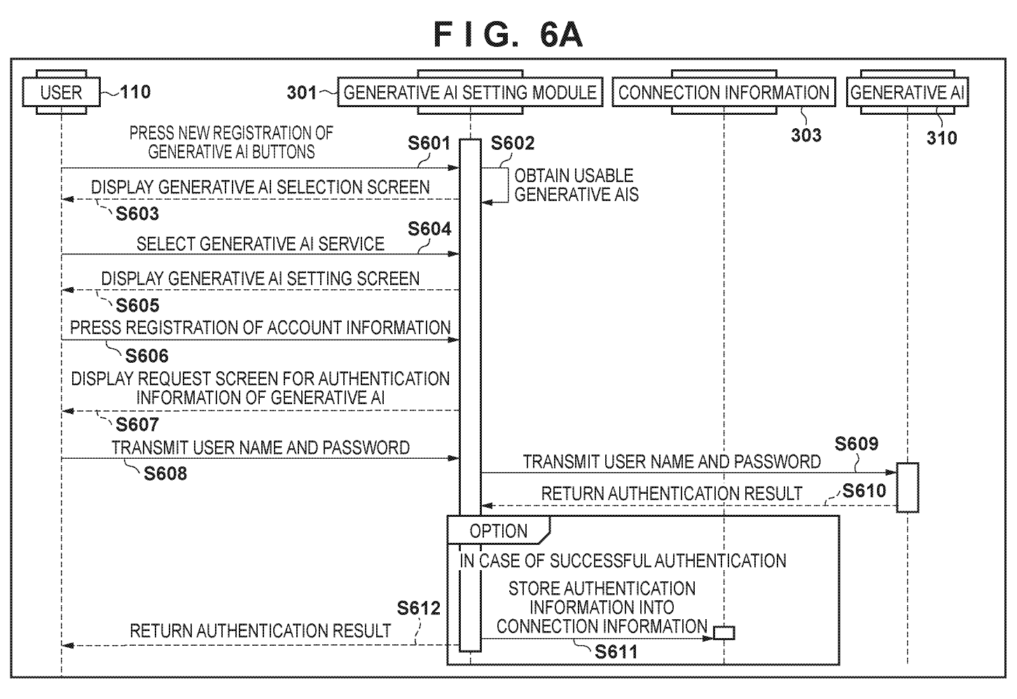

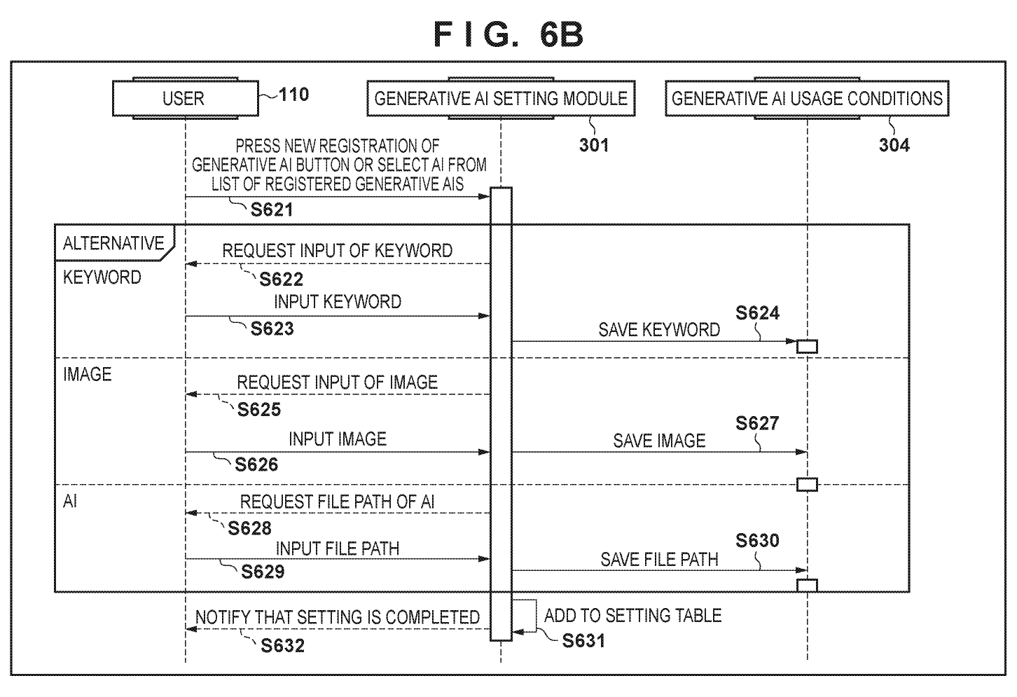

The sequence diagrams in FIGS. 6A and 6B illustrate a processing flow and cooperation between functional modules in each embodiment according to the present disclosure when the user of the information processing apparatus 101 sets the generative AI 310 (FIG. 3B) in the cloud 103 and the usage conditions thereof. This sequence is realized by the CPU 210 of the information processing apparatus 101 loading a program stored in the ROM 212 into the RAM 213 and executing the program.

FIG. 6A is a sequence diagram for describing generative AI setting processing in the first embodiment.

In step S601, the user 110 operating the information processing apparatus 101 presses the “new registration of generative AI” button 402 on the setting screen 400 (FIG. 4A) displayed on the display 216. Accordingly, in step S602, the generative AI setting module 301 obtains usable generative AIs that can be used. In the first embodiment, usable generative AIs are held in the generative AI setting module 301, but they may be in any format such as a database, and may be held in, for example, a device other than the information processing apparatus 101. Next, in step S603, the generative AI setting module 301 presents the generative AI selection screen 410 (FIG. 4B) to the user 110.

Next, in step S604, the user 110 selects a desired generative AI service from the generative AI list 411 on the selection screen 410. Here, it is assumed that the user 110 has selected “generative AI-1”, for example. Next, in step S605, the generative AI setting module 301 displays the setting screen 420 (FIG. 4C) for the “generative AI-1” to the user 110. Then, in step S606, the user 110 presses the “account information registration” button 422.

Accordingly, in step S607, the generative AI setting module 301 displays the authentication screen 430 for the generative AI (FIG. 4D). Then, the processing proceeds to step S608, and, on the authentication screen 430, the user 110 inputs the user name thereof into the ID text box 431 and the password thereof into the password text box 432, and presses the login button 433. Accordingly, in step S609, the generative AI setting module 301 transmits the user name input into the ID text box 431 and the password input into the password text box 432 to the generative AI 310 to perform authentication.

In step S610, the generative AI 310 transmits an authentication result to the generative AI setting module 301. If the authentication is successful here, in step S611, the generative AI setting module 301 stores the authentication information into the connection information 303. Then, in step S612, the generative AI setting module 301 notifies the user 110 of the authentication result. Upon completion of step S612, the setting of the generative AI to be used is completed.

FIG. 6B is a sequence diagram when setting generative AI usage conditions.

First, in step S621, the user 110 starts setting the generative AI usage conditions by pressing the “new registration of generative AI” button 402 or selecting a generative AI for which usage conditions are to be set from the generative AI list 401. Accordingly, in step S622, step S625, and step S628, the generative AI setting module 301 requests a keyword, an image, and AI settings from the user 110. Accordingly, it is assumed that the user 110 inputs, for example, a keyword to be restricted to set the usage conditions for the generative AI. In this case, the generative AI setting module 301 displays the keyword registration screen 440 (FIG. 4A) and requests a keyword from the user 110. Accordingly, in step S623, the user 110 inputs a keyword to be restricted into the text box 441 and, with the radio button group 442, selects whether to permit or prohibit usage of the generative AI based on the presence or absence of the input keyword. For example, in a case where the user 110 does not wish to transmit a document containing a name to the generative AI specified in step S621, the user 110 inputs the name into the text box 441 and, with the radio button group 442, selects “unusable when this keyword is included”. By this, the transmission of a document containing a name can be restricted by making the generative AI unusable when the name is included. Upon completion of the input into the text box 441 and the radio button group 442, the user 110 presses the OK button 443 to complete this processing. Thus, in step S624, the generative AI setting module 301 stores the information of the text box 441 and the radio button group 442 input by the user 110, into the generative AI usage conditions 304, and terminates this processing.

Next, a case where the user 110 sets usage conditions for a generative AI using an image will be described. In this case, in step S625, the generative AI setting module 301 displays the image registration screen 450 (FIG. 4F) and requests input of an image to be restricted from the user 110. In step S626, the user 110 presses the file selection button 452 and selects the file of the image. The image selected by the user 110 in this way is displayed in a preview 454. Then, the user 110 selects, via the radio button group 451, whether the target generative AI (here, the “Generative AI-1”) is to be made usable or unusable when the image is included. Upon completion of these inputs, the user 110 completes the processing by pressing the OK button 453. Accordingly, in step S627, the generative AI setting module 301 stores the information of the radio button group 451 and the file selection button 452 input by the user 110 via the image registration screen 450, into the generative AI usage conditions 304, and terminates this processing.

Next, a case where the user 110 sets usage conditions for a generative AI using an AI will be described. In step S628, the generative AI setting module 301 displays the AI registration screen 460 (FIG. 4G) and requests a file path of an AI from the user 110. Accordingly, in step S629, the user 110 inputs the file path of the AI into the text box 461. Then, the user 110 selects, via the radio button group 462, whether the target generative AI is to be made usable or unusable according to the determination by the AI. Upon completion of the input on the AI registration screen 460, the user 110 presses the OK button 463 to complete this processing. Thus, in step S630, the generative AI setting module 301 stores the file path of the AI input by the user 110 into the text box 461 and the information of the radio button group 462 into the generative AI usage conditions 304.

In step S631, the generative AI setting module 301 newly adds the generative AI usage conditions input in this manner to the registered conditions 428 (FIG. 4C), which is a setting table, and displays the same. In step S632, the generative AI setting module 301 notifies the user 110 that the setting of the generative AI usage conditions is completed.

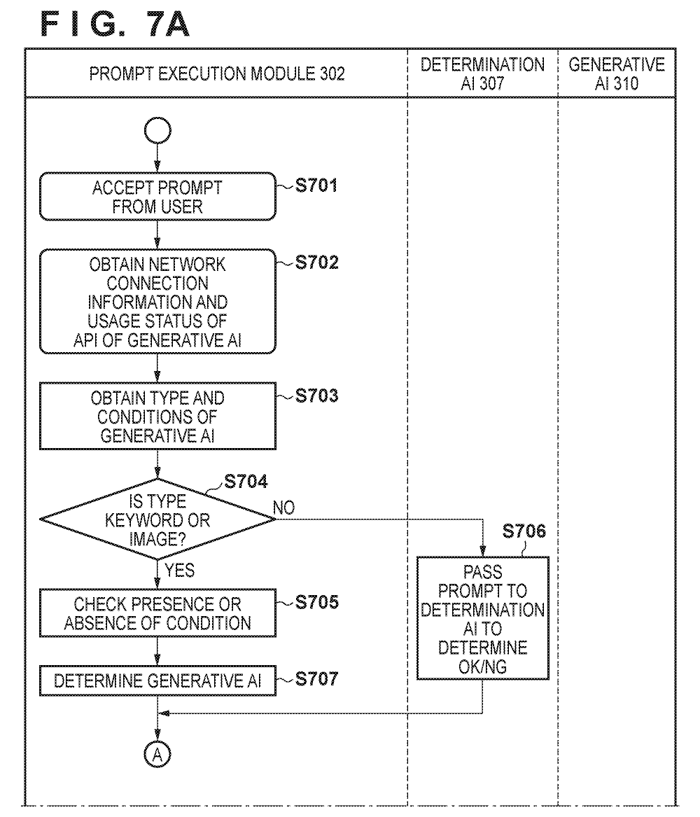

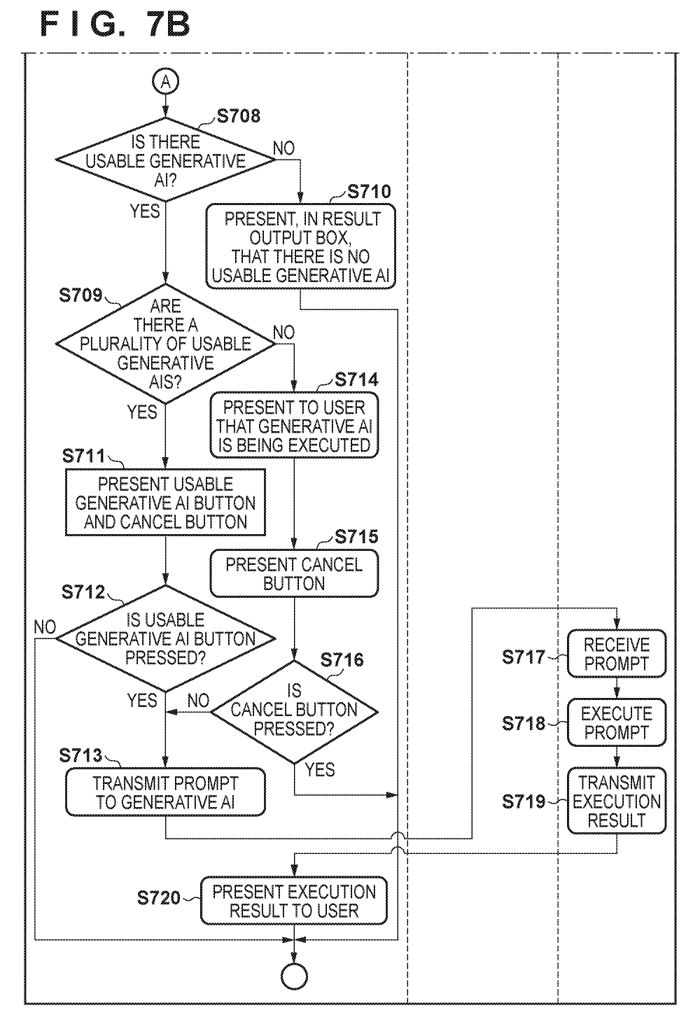

FIGS. 7A and 7B are flowcharts for describing a processing flow of the entire system when processing is executed using a generative AI based on a prompt input via the information processing apparatus 101 according to the first embodiment. Note that, in FIGS. 7A and 7B, processing by the prompt execution module 302 of the information processing apparatus 101 is realized by the CPU 210 of the information processing apparatus 101 loading a program stored in the ROM 212 into the RAM 213 and executing the program. Note that prior to the start of the processing shown in this flowchart, it is necessary for the user to set the above-mentioned generative AI usage conditions in advance. This processing is started by a prompt being input into the text box 501 displayed on the display 216 of the information processing apparatus 101. Note that, in the first embodiment, the prompt is input by the user via the prompt input and output screen 500, but the prompt may be input in any manner, such as through an API from another application.

First, in step S701, the CPU 210 accepts input of a prompt from the user 110. The acceptance method here is to accept the prompt from the user 110 by having the user 110 input the prompt into the text box 501 and press the execution button 502. Next, the processing proceeds to step S702, and the CPU 210 functions as the prompt execution module 302 to obtain the Internet connection status and the upper limit of the number of uses of the API. Note that, in the following description, when the CPU 210 functions as the prompt execution module 302, the prompt execution module 302 will be described as the entity performing the processing (steps). The Internet connection status is obtained by the network information obtaining module 305 using the communication I/F 215. Further, the upper limit of the number of uses of the API may be obtained in any manner as long as the number of times the API has been used can be identified, such as the generative AI usage status 306 counting the number of times the API has been used or obtaining the same from a generative AI service using the API.

Next, the processing proceeds to step S703 and the prompt execution module 302 obtains data indicating a usage condition from the generative AI usage conditions 304. Thereafter, the processing proceeds to step S704 and the prompt execution module 302 determines whether or not the type of the usage conditions is a keyword or an image. In step S704, upon determining that the type of the usage conditions is a keyword or an image, the processing proceeds to step S705. On the other hand, if the type of the usage conditions is not a keyword or an image, that is, in the case of determination by an AI, the processing proceeds to step S706. In step S705, the prompt execution module 302 checks whether or not the input prompt includes a word or an image that matches the registered usage conditions. For example, if a user’s name is specified in the usage conditions, the prompt execution module 302 checks whether or not the user’s name is included in the input prompt, and the processing proceeds to step S707. In step S707, the prompt execution module 302 determines whether or not there is a usable generative AI with reference to the determination criterion of the generative AI usage conditions 304, and the processing proceeds to step S708. On the other hand, in step S706, the prompt execution module 302 passes the input prompt to the determination AI 307 specified in the generative AI usage conditions 304, has the determination AI 307 determine whether or not there is a usable generative AI, and the processing proceeds to step S708 upon receiving a response therefrom.

In step S708, the prompt execution module 302 determines whether or not there is a usable generative AI based on the determination result in step S707 or the response from the determination AI 307. Here, if it is determined that there is a usable generative AI, the processing proceeds to step S709, and if it is determined that there is no usable generative AI, the processing proceeds to step S710. In step S710, the prompt execution module 302 presents, to the user, in the text box 503 (FIG. 5A), information indicating that there is no usable generative AI, and the prompt execution module 302 terminates this processing.

In step S709, the prompt execution module 302 determines whether or not there are a plurality of usable generative AIs. Here, if it is determined that there are a plurality of usable generative AIs, the processing to step S711, and if it is determined that there are not a plurality of usable generative AIs, the processing proceeds to step S714. In step S711, the prompt execution module 302 displays a button group 512 and a flow cancel button 513 in an area 511 (FIG. 5C). For example, it is assumed that the user has set the generative AI-1, the generative AI-2, and the generative AI-3 in advance. If it is determined in step S709 that the generative AI-1 and the generative AI-2 are usable, in step S711, the prompt execution module 302 displays the generative AI-1 and the generative AI-2 in the button group 512 as shown on the input and output screen 520 in FIG. 5C.

Next, the processing proceeds to step S712, and in response to the user selecting a generative AI, the processing proceeds to step S713. On the other hand, if the cancel button 513 is pressed and cancellation is selected in step S712, the prompt execution module 302 terminates this processing. In step S713, the prompt execution module 302 transmits the prompt to the generative AI selected by the user.

Accordingly, the processing proceeds to step S717, and a server in which the generative AI 310 selected by the user is present receives the prompt. In step S718, the generative AI 310 executes the prompt. In step S719, the generative AI 310 transmits an execution result of the prompt to the prompt execution module 302.

Thus, the processing proceeds to step S720, and the prompt execution module 302 displays the execution result of the prompt in the text box 503, and terminates this processing. Here, for example, it is assumed that the prompt “Please tell me recommended travel destinations for summer vacation” has been accepted in step S701 as shown on the input and output screen 520 in FIG. 5C. Accordingly, it is assumed that the “generative AI-2” has been selected in step S712 from the determination results, which are the usable generative AIs determined in step S707. Accordingly, in step S713, the prompt execution module 302 transmits the input prompt to the selected “generative AI-2”. Thus, the processing by the “generative AI-2” is executed in steps S717 to S719, and the result is received from the “generative AI-2”. Then, in step S720, the execution result “Recommended spots as travel destinations for summer vacation” received from the “generative AI-2” is displayed in the text box 503. The input and output screen 520 in FIG. 5C represents this from the user’s perspective.

In step S714, the prompt execution module 302 presents to the user that the generative AI is being executed. Here, a message “Executing” is output to the text box 503 of the input and output screen 520 in FIG. 5C. Note that the present disclosure is not limited to this, and any other message may be used as long as it can notify the user that the generative AI is being executed. Next, the processing proceeds to step S715 and the prompt execution module 302 presents the cancel button 513 to the user. Thereafter, the processing proceeds to step S716 and the prompt execution module 302 determines whether or not the user has pressed the cancel button 513, and the processing proceeds to step S720 if the cancel button 513 has been pressed, and the processing proceeds to step S713 if the cancel button 513 has not been pressed.

As described above, according to the first embodiment, before starting processing in response to an input prompt, the generative AIs usable for the prompt can be presented to the user so as to be selected. This provides an effect of solving a problem that the user cannot select a generative AI to which an input prompt is to be output.

### Second Embodiment

A second embodiment describes a case where a generative AI and a determination AI cannot be installed together in the information processing apparatus 101 due to machine constraints of the information processing apparatus 101. The information processing apparatus 101 according to the second embodiment does not include the determination AI 307 according to the first embodiment, but includes a generative AI 327. Note that since a system configuration and the like according to the second embodiment are substantially equivalent to those of the first embodiment described above, points different from the first embodiment will be described in detail below.

FIG. 2C is a block diagram for describing a hardware configuration of an information processing apparatus 101 according to the second embodiment of the present disclosure.

The information processing apparatus 101 includes a CPU 230, a ROM 232, a RAM 233, a storage 234, a communication I/F 235, and a display 236. The CPU 230, the ROM 232, the RAM 233, the communication I/F 235, and the display 236 play the same roles as the CPU 210, the ROM 212, the RAM 213, the storage 214, the communication I/F 215 of the information processing apparatus 101 in FIG. 2A. However, it is assumed that the storage 234 has a smaller capacity than the storage 214 in FIG. 2A.

FIG. 3C is a functional block diagram for describing a software configuration of the information processing apparatus 101 according to the second embodiment.

In the information processing apparatus 101 in FIG. 3C, an application 320 includes the generative AI setting module 301, the prompt execution module 302, the network information obtaining module 305, and the generative AI usage status 306, as in FIG. 3A. Furthermore, this information processing apparatus 101 includes the generative AI 327, which is a generative AI operating in the information processing apparatus 101. The connection information 303 and the generative AI usage conditions 304 are also basically the same as those in the first embodiment described above.

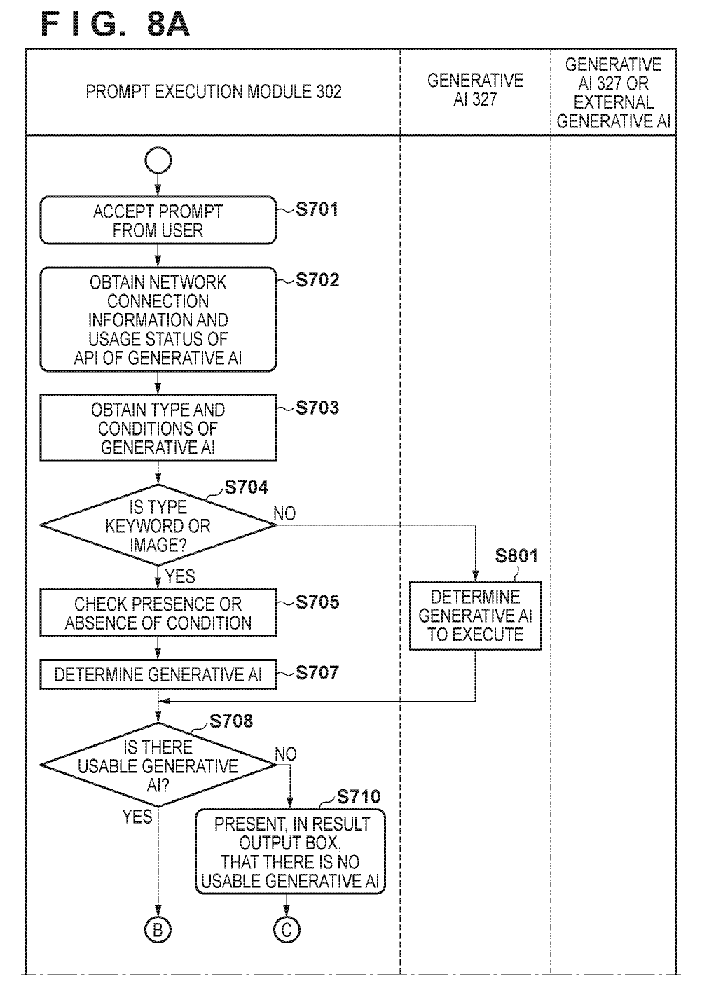

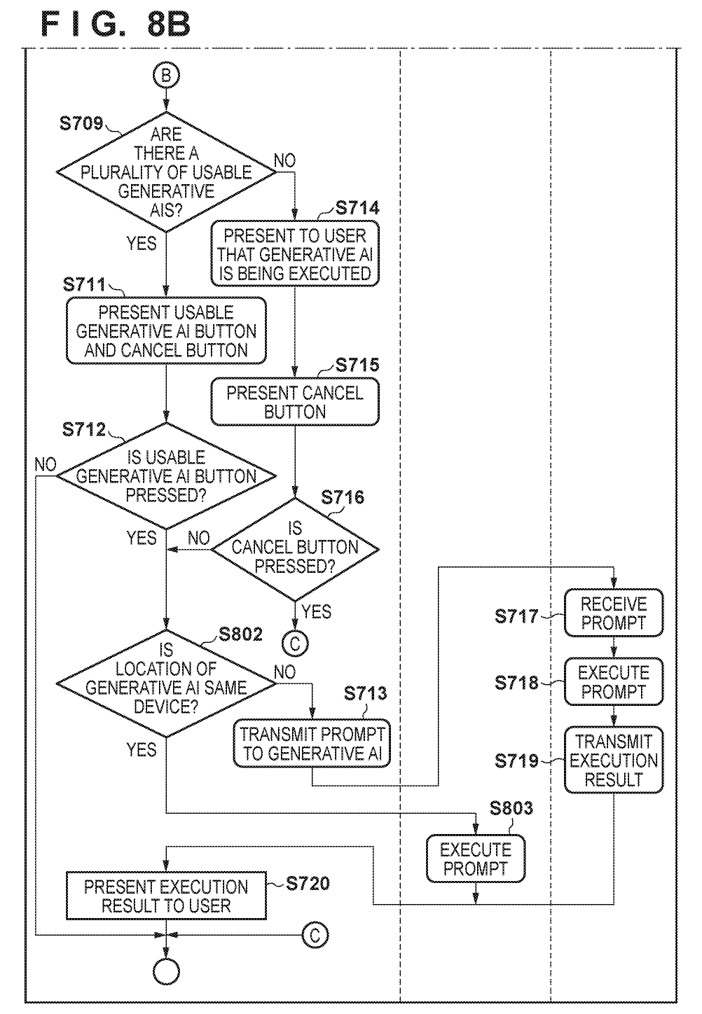

FIGS. 8A and 8B are flowcharts for describing a processing flow when processing is executed using a generative AI based on a prompt input via the information processing apparatus 101 according to the second embodiment. Note that, in FIGS. 8A and 8B, processing by the prompt execution module 302 of the information processing apparatus 101 is realized by the CPU 210 of the information processing apparatus 101 loading a program stored in the ROM 212 into the RAM 213 and executing the program. Note that prior to the start of the processing shown in this flowchart, it is necessary for the user to set the above-mentioned generative AI usage conditions in advance. In addition, this processing is started by a prompt being input into the text box 501 displayed on the display 216 of the information processing apparatus 101. Note that, in FIGS. 8A and 8B, the same processing as in FIGS. 7A and 7B described above is denoted by the same reference numerals, and description thereof will be omitted.

In step S704, if the type of the conditions is not a keyword or an image, that is, in the case of determination by AI, the processing proceeds to step S801. In step S801, the prompt execution module 302 passes the prompt to the generative AI 327, and the generative AI 327 determines, based on contents learned in advance, a generative AI that can execute the input prompt, and returns the result to the prompt execution module 302, and the processing proceeds to step S708.

In step S712, the prompt execution module 302 transitions to step S802 in response to a generative AI being selected by the user. In step S802, the prompt execution module 302 determines whether or not the generative AI selected by the user is in the information processing apparatus 101. If it is determined that the generative AI is in the information processing apparatus 101, the processing proceeds to step S803. In step S803, the prompt execution module 302 passes the prompt to the generative AI 327, and the generative AI 327 executes the prompt. In this case, processing based on the prompt is executed by the generative AI 327 in steps S717 to S719. On the other hand, if it is determined in step S802 that the generative AI is not in the information processing apparatus 101, the processing proceeds to step S713 and the prompt execution module 302 transmits the prompt to an external generative AI selected by the user, for example, a generative AI in a cloud. Accordingly, processing based on the prompt is executed by the external generative AI in steps S717 to S719.

As described above, according to the second embodiment, a generative AI that executes an input prompt can be determined by using generative AI operating in the information processing apparatus. This can solve the problem of the first embodiment in a case where a generative AI and a determination AI cannot be installed together in the information processing apparatus due to machine constraints. That is, even in a case where generative AI and AI for determination cannot be installed together in the information processing apparatus 101, it is possible to achieve an effect that the user can input a prompt and select a generative AI to be used.

### Third Embodiment

A third embodiment describes an example in which it is possible to specify a generative AI at the time of inputting a prompt.

FIG. 5D depicts a view illustrating an example of a prompt input and output screen 530 according to the third embodiment. This input and output screen 530 shows an example of a screen in a case where a generative AI specified at the time of inputting a prompt is unusable.

In FIG. 5D, the user inputs a prompt into the text box 501, specifies the “generative AI-2” with a button group 515 in an area 514 of the input and output screen 530, and then presses the execution button 502. Accordingly, the prompt execution module 302 determines whether or not the “generative AI-2” is usable, using the value input into the text box 501 as a prompt. As a result, if it is determined that the “generative AI-2” is unusable, the prompt execution module 302 displays “This prompt cannot be executed by the generative AI-2. Please specify another generative AI” in the text box 503 to warn the user. Accordingly, upon confirming that the specified generative AI is unusable for the prompt, the user can cancel the processing using the “generative AI-2” by pressing the cancel button 516. Note that, in the third embodiment, although a warning message is displayed in the text box 503, any format may be used as long as the user can be informed that the specified generative AI is unusable.

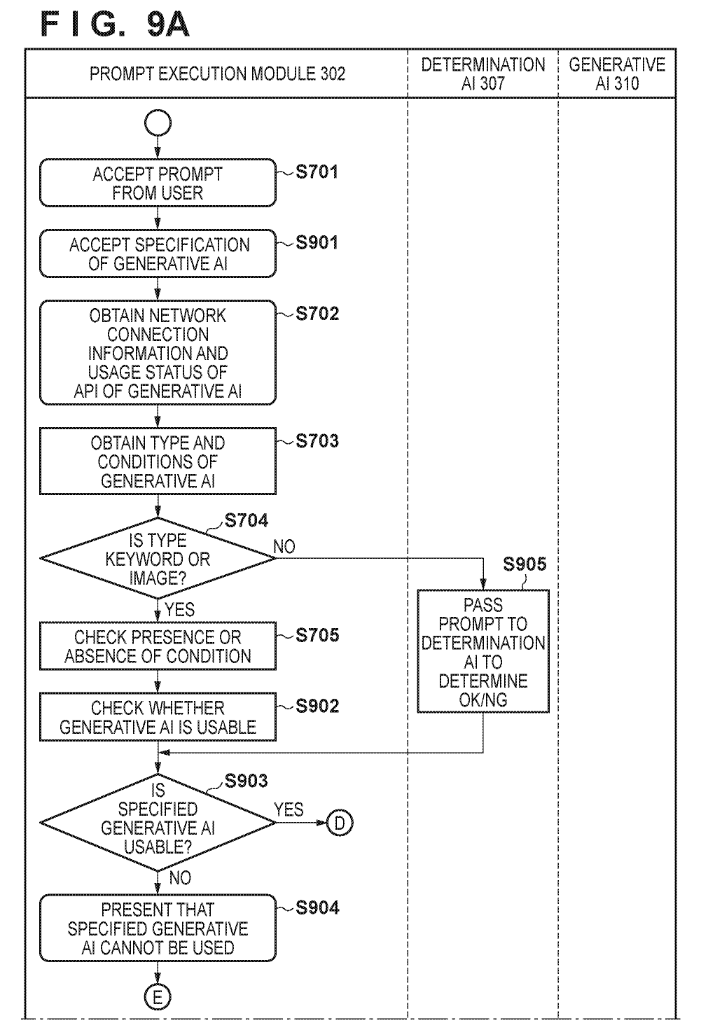

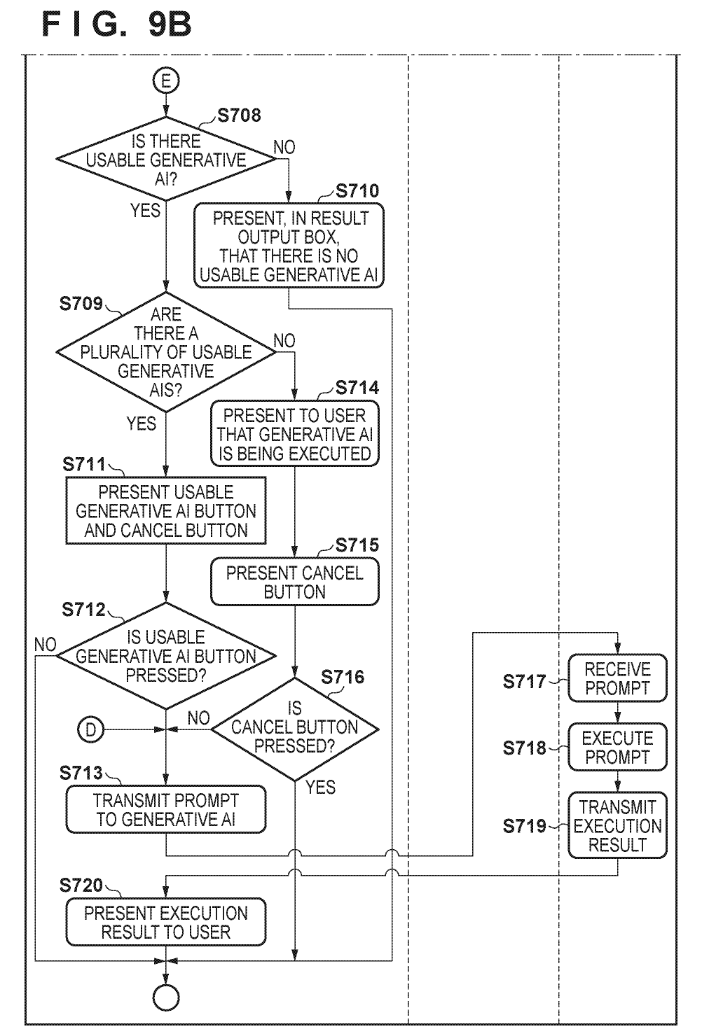

FIGS. 9A and 9B are flowcharts for describing a processing flow when processing is executed using a generative AI based on a prompt input via the information processing apparatus 101 according to the third embodiment. Note that, in FIGS. 9A and 9B, processing by the prompt execution module 302 of the information processing apparatus 101 is realized by the CPU 210 of the information processing apparatus 101 loading a program stored in the ROM 212 into the RAM 213 and executing the program. Note that prior to the start of the processing shown in this flowchart, it is necessary for the user to set the above-mentioned generative AI usage conditions in advance. This processing is started by a prompt being input into the text box 501 displayed on the display 216 of the information processing apparatus 101. Note that, in FIGS. 9A and 9B, the same processing as in FIGS. 7A and 7B described above is denoted by the same reference numerals, and description thereof will be omitted.

In step S901, the prompt execution module 302 accepts specification of a generative AI from the user. Generative AIs that can be specified by the user are limited to generative AIs set by the user in advance, and are displayed in, for example, a button group 515 in FIG. 5D. In the first embodiment described above, the button group 512 in FIG. 5B displays only usable generative AIs as a result of determination based on settings by the user, such as usage conditions. However, in the third embodiment, all generative AIs set by the user are displayed in the button group 515. Therefore, this button group 515 also includes generative AIs that cannot execute the prompt input by the user.

In step S902, the prompt execution module 302 checks whether or not the generative AI accepted in step S901 is usable with reference to the determination criterion of the generative AI usage conditions 304, and the processing proceeds to step S903. On the other hand, if it is determined in step S704 that the determination is to be performed by an AI, the processing proceeds to step S905. In the determination using a determination AI in step S905, it is determined whether or not the generative AI specified by the user can be used to process the prompt input by the user, and processing proceeds to step S903.

In step S903, the prompt execution module 302 determines, based on the result of the check in step S902 or the result of the determination in step S905, whether or not the generative AI specified by the user, which has been obtained in step S901, is usable for the input prompt. If it is determined that the generative AI specified by the user is usable, the processing proceeds to step S713 and the prompt execution module 302 transmits the prompt to the generative AI. On the other hand, if it is determined that the generative AI is unusable, the processing proceeds to step S904. In step S904, the prompt execution module 302 displays information indicating that the generative AI specified by the user is unusable, as shown in, for example, the text box 503 in FIG. 5D, and the processing proceeds to step S708.

As described above, according to the third embodiment, in addition to the processing in the first embodiment, the user can input a prompt and, at the same time, specify a generative AI that the user wishes to use for the prompt. Thus, it is possible to improve usability because inputting a prompt and specifying a generative AI to be used to process the prompt can be performed in parallel. If the input prompt cannot be processed by the specified generative AI, information indicating that fact is displayed. Thus, for example, in a case where a prompt includes personal information or highly confidential information, it is possible to specify only a highly secure generative AI that prevents such information from leaking onto the Internet, and have that generative AI execute the input prompt.

As described above, according to the embodiment, the user can select a usable generative AI based on information input by the user to the generative AI, and therefore the user can safely use the generative AI.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to Japanese Patent Application No. 2025-079852, filed May 12, 2025, which is hereby incorporated by reference herein in its entirety.

What is claimed is:

1. An information processing apparatus comprising:
one or more controllers including one or more processors in communication with one or more memories, the one or more controllers configured to:
accept input of a prompt;
set one or more usable generative AIs and usage conditions for the generative AIs;
determine, based on the accepted prompt and the set usage conditions, a target generative AI to process the prompt, included in the usable generative AIs; and
perform control to output the prompt to the target generative AI, thereby causing the target generative AI to perform processing of the prompt, and to receive a result of the processing from the target generative AI.

2. The information processing apparatus according to claim 1,
wherein, in the determining the target generative AI, in a case where a plurality of generative AIs are set as the one or more usable generative AIs and a plurality of generative AIs are capable of processing the prompt, the one or more controllers present, to a user, the plurality of generative AIs capable of processing the prompt, and cause the user to select the target generative AI.

3. The information processing apparatus according to claim 1,
wherein, in the determining the target generative AI, in a case where the one or more controllers determine that no target generative AI exists, the one or more controllers present, to the user, information indicating that no generative AI is capable of processing the prompt.

4. The information processing apparatus according to claim 1,
wherein the usage conditions include information used to determine whether or not the generative AI is usable and a determination criterion indicating whether or not the generative AI is usable in accordance with the information.

5. The information processing apparatus according to claim 4,
wherein the information includes text or an image.

6. The information processing apparatus according to claim 4,
wherein, in a case where the information includes information specifying a determination AI for determining whether or not the generative AI is usable, the usage condition further includes a path of the determination AI.

7. The information processing apparatus according to claim 6,
wherein, in the determining the target generative AI, in a case where the information includes information specifying a determination AI for determining whether or not the generative AI is usable, the one or more controllers determine the target generative AI based on a response from the determination AI.

8. The information processing apparatus according to claim 6, further comprising
a determination AI for determining the target generative AI in a case where the information includes information specifying a determination AI for determining the target generative AI.

9. The information processing apparatus according to claim 6, further comprising
a generative AI for determining the target generative AI in a case where the information includes information specifying a determination AI for determining the target generative AI.

10. An information processing apparatus comprising:
one or more controllers including one or more processors in communication with one or more memories, the one or more controllers configured to:
accept input of a prompt;
specify a target generative AI for executing the prompt;
set usage conditions for the target generative AI;
perform a determination of usability, based on the accepted prompt and the set usage conditions, to determine whether or not the specified target generative AI is usable for processing the prompt; and
upon determining that the specified target generative AI is usable, perform control to output the prompt to the target generative AI, thereby causing the target generative AI to perform processing of the prompt, and to receive a result of the processing from the target generative AI.

11. The information processing apparatus according to claim 10,
wherein, in the determination of usability, the one or more controllers determine whether or not the specified target generative AI is usable for processing the prompt, further based on an Internet connection status.

12. The information processing apparatus according to claim 10,
wherein, in the determination of usability, the one or more controllers determine whether or not the specified target generative AI is usable for processing the prompt, based on an upper limit of a number of uses of generative AI.

13. The information processing apparatus according to claim 10,
wherein, upon determining that the specified target generative AI is not usable, the one or more controllers present one or more generative AIs capable of processing the prompt, included in usable generative AIs.

14. The information processing apparatus according to claim 13,
wherein, in a case where a plurality of generative AIs are capable of processing the prompt, the one or more controllers further present, to a user, the plurality of generative AIs capable of processing the prompt, and cause the user to select the target generative AI.

15. A method of controlling an information processing apparatus, comprising:
accepting input of a prompt;
setting one or more usable generative AIs and usage conditions for the generative AIs;
determining, based on the accepted prompt and the set usage conditions, a target generative AI to process the prompt, included in the usable generative AIs; and
performing control to output the prompt to the target generative AI, thereby causing the target generative AI to perform processing of the prompt, and to receive a result of the processing from the target generative AI.

16. A method of controlling an information processing apparatus, comprising:
accepting input of a prompt;
specifying a target generative AI for executing the prompt;
setting usage conditions for the target generative AI;
determining, based on the accepted prompt and the set usage conditions, whether or not the specified target generative AI is usable for processing the prompt; and
upon determining that the target generative AI is usable for processing the prompt, performing control to output the prompt to the target generative AI, thereby causing the target generative AI to perform processing of the prompt, and to receive a result of the processing from the target generative AI.

17. A non-transitory computer-readable storage medium storing a program for causing a processor to execute a method of controlling an information processing apparatus, comprising:
accepting input of a prompt;
setting one or more usable generative AIs and usage conditions for the generative AIs;
determining, based on the accepted prompt and the set usage conditions, a target generative AI to process the prompt, included in the usable generative AIs; and
performing control to output the prompt to the target generative AI, thereby causing the target generative AI to perform processing of the prompt, and to receive a result of the processing from the target generative AI.

18. A non-transitory computer-readable storage medium storing a program for causing a processor to execute a method of controlling an information processing apparatus, comprising:
accepting input of a prompt;
specifying a target generative AI for executing the prompt;
setting usage conditions for the target generative AI;
determining, based on the accepted prompt and the set usage conditions, whether or not the specified target generative AI is usable for processing the prompt; and
upon determining that the target generative AI is usable for processing the prompt, performing control to output the prompt to the target generative AI, thereby causing the target generative AI to perform processing of the prompt, and to receive a result of the processing from the target generative AI.
